(19) United States
(12) Patent Application Publication
(10) Pub. No.: US 2012/0209791 A1
(43) Pub. Date: Aug. 16, 2012

(54) SYSTEM FOR PROVIDING A TAILORED INVESTMENT OPTION FOR APATHETIC INVESTORS

(76) Inventor: Lionel Bucknell, Woollahra (AU)

(21) Appl. No.: 13/500,642

(22) PCT Filed: Dec. 14, 2010
(86) PCT No.: PCT/AU2010/001684

§ 371 Date: Apr. 6, 2012

(30) Foreign Application Priority Data
Jan. 3, 2010 (AU) 2010900006
May 1, 2010 (AU) 2010201745

(51) Int. Cl. G06Q 40/06

(52) U.S. Cl. 705/36 R

(57) ABSTRACT

An investment system for collecting, adjusting, monitoring and directing data from beneficiaries, customers, superannuation member accounts (investors) where the investor has not made any direction or indication of the third party controlling entity in regards to the investment option, style or type. The system computes a matrix of hurdle levels (potential goals or targets) across the whole pool of eligible investors and sets glide paths (percentage of growth of assets at different stages of the investment) for each of the hurdles. The system automatically provides asset allocations and advice to individual investors and provides asset allocations and advice to third party entities such as a trustee organisation managing investors' funds.

### CROSS-REFERENCE TO RELATED APPLICATION

This application is the U.S. national phase of PCT Appln. No. PCT/AU2010/001684 filed on Dec. 14, 2010, which claims priority to AU Patent Application No. 2010900006 filed on Jan. 3, 2010 and AU Patent Application No. 2010201745 filed on May 1, 2010, the disclosures of which are incorporated in their entirety by reference herein.

### TECHNICAL FIELD

This invention is an investment program utilising a computer system to collect, adjust, monitor and direct data from beneficiaries, customers and superannuation member accounts (investors) where the investor has not made any direction or indication to a third party controlling entity in regard to the investment option, style, or type.

### BACKGROUND

Any reference to prior art in this specification is not and should not be taken as an acknowledgement or any form of suggestion that the prior art form part of the common general knowledge.

There are many sectors and investment arrangements, controlled by a third party entity, to which this invention is directly applicable. For example, the superannuation (or pension) sector in Australia, which has evolved particularly since 1992. The structure of this sector involves trust arrangements controlled by trustee organisations or individuals with fiduciary obligations to act in their investors' best interests. Typically an investor has an ‘account’ in which deposits are made, and eventually from which benefits are paid. Investors often are able to choose how their account (in part or in full) is invested (investment choice), for example in shares, as a balanced option or in cash. However the vast majority of investors, often 80-90%, do not actively choose an investment option. It is therefore left up to the controlling third party entity (trustee in this example) to choose how to invest these monies.

Currently there are three main methods used to make this choice—the default option, life-stage option, and target date, plus several lesser used methods.

The default option involves the trustee establishing an investment option (often called the default option), as the default, and investing those customers' accounts who have not chosen another investment option in that default option. This default option investment criteria (i.e. 30% income assets, 70% growth assets) is set having regard to expected returns (earnings per year) and expected volatility (risk or number of years a loss will be made for example). In addition the whole age profile of all the investors may be taken into account.

The life-stage option uses the investor's age only to choose an investment option. For example if the investor is 20 years old, the share option is chosen, whereas if the investor is 65 years old then the cash option is chosen.

The target date option involves an investor being placed in a sub fund correlating to their year of retirement, i.e. the 2050 fund for a 25 year old (in 2010) retiring in 2050 (at age 65). Each of these funds uses a ‘glide path’ (i.e. percentage of growth assets at different ages) as the system of allocating investment risk and return.

The other lesser used options require the investor to make a choice (no default) or undertake a full financial assessment or plan, and are not applicable here.

The problems with the three above options and the solution thereto (this invention) became apparent to me during the period April-October 2008, whilst I was overseas on a sabbatical and the global financial crisis (GFC) was in full swing. The issues with the approaches above is that during the GFC, the expected risk/return ratios did not hold true, investors largely did not withdraw monies or transfer to another entity even where large losses were made. Some investors close to withdrawing their funds suffered larger more unexpected losses than was needed.

### SUMMARY

This invention solves the issue of non direction of investment option in a more efficient manner across the whole pool of investors in the pension, superannuation, trust or other collective investment environments where there is a controlling third party entity.
This inventions benefits include:

Increased average end balances, as greater risk can be appropriately taken;

Lower volatility as the withdrawal date approaches;

Concentration by the investor on the longer term result;

Focus on balances, contribution and withdrawal rates and risk reward ratios in the context of what will be able to be afforded with the end balance, and

Third party controlling entities being able to more closely align investor best interests with investment options 1.

Appropriate assets allocation and advice is essential for improved outcomes.

### BRIEF DESCRIPTION OF THE DRAWINGS

FIG. 1a is a flowchart of how interaction with the current investment structures might occur.

FIG. 1b is a continuation of the flowchart of FIG. 1a.

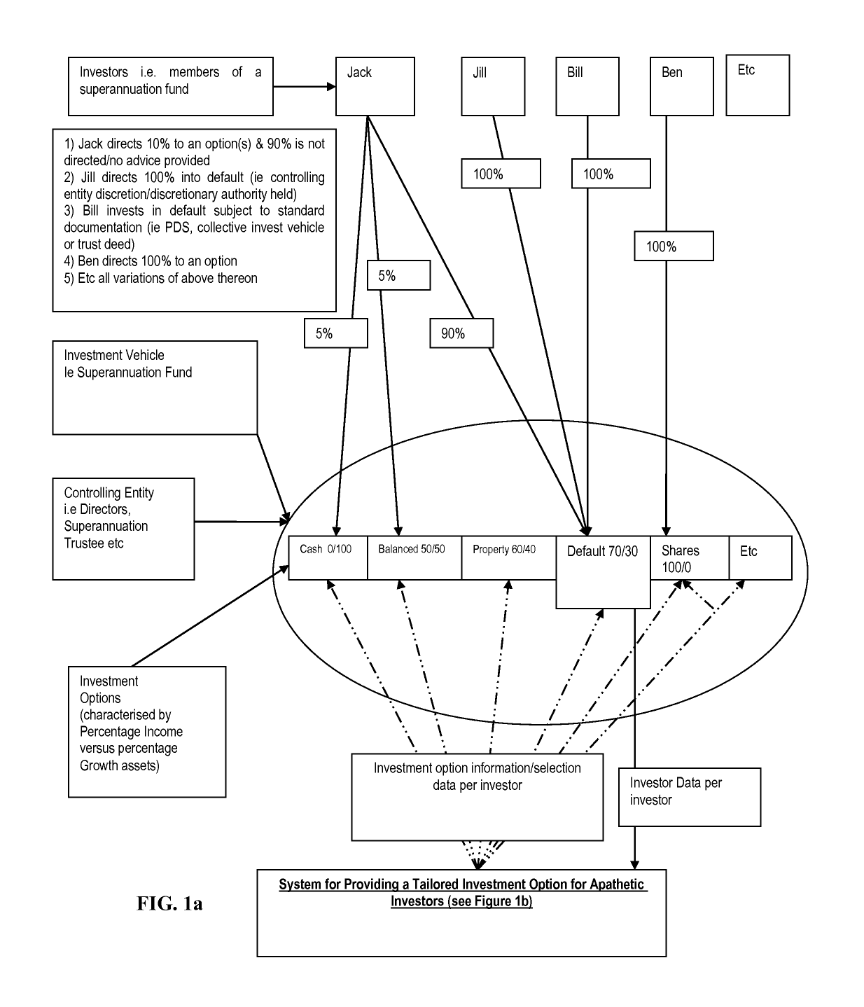

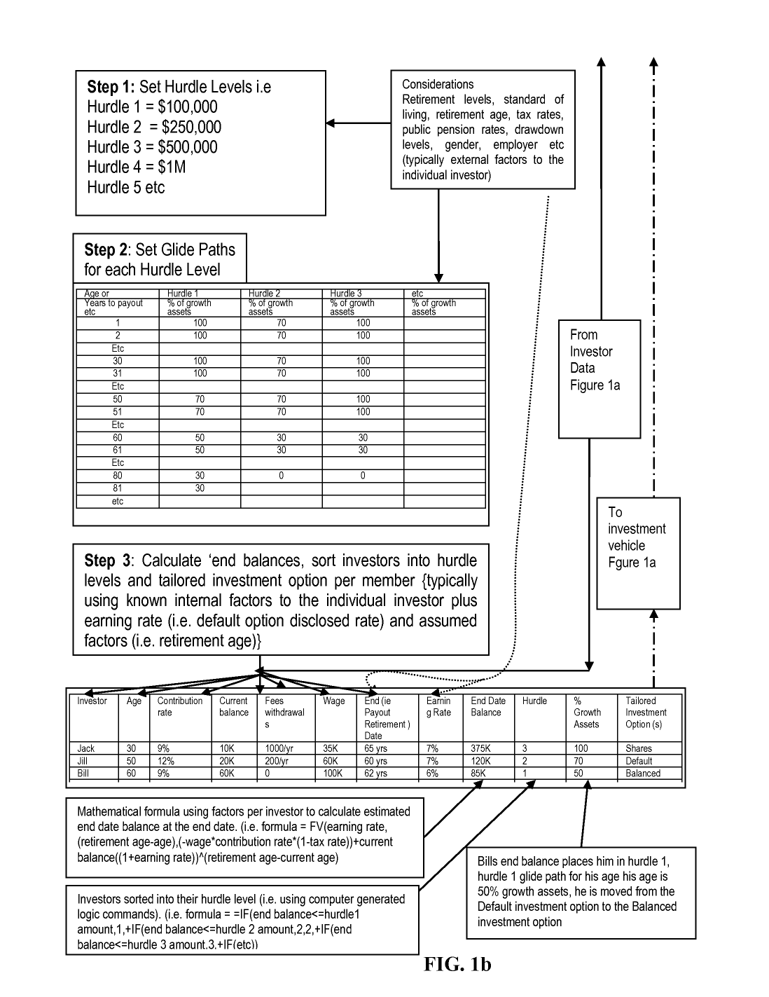

The attached diagrams in FIGS. 1a and 1b depict how interaction with current investment structures might occur in an example of this invention.

### DETAILED DESCRIPTION

The invention uses a business method to combine factors, both internal and external to the collective investment data pool, but known by the controlling third party entity, in a set system to derive the appropriate investment option for each investor.

The business method includes the interaction of a physical process with the three step method described below. It involves:

1. Developing a matrix of ‘hurdle levels’ across the whole pool of eligible investors.

2. Setting glide paths for each of these hurdle levels, and

3. Using a computer implemented method of providing an asset allocation (and advice) to individual investors and the controlling third party entity.

### Step 1

The hurdle levels are set for each period, for example hurdle 1 may be an end benefit of $100,000, hurdle 2 $250,000, Hurdle 3 $500,000, and hurdle 4 $1 Million etc. The hurdles are set based on the expected level of retirement that could be afforded at this level, the expectation of the need to delay retirement for financial reasons, the known tax rates and different income draw down levels, lifetime/style expected at different income levels etc (typically external factors).

### Step 2

For each hurdle level a glide path is set. For example for hurdle 1 90% growth assets for ages up to 50 years, then 80% to 55 years, then 70% to 65 years, then 50%. These growth asset percentages take into account the factors outlined in step 1. For example hurdle 1 will be within the tax free threshold level, therefore the investor will ultimately keep all the earnings made and should therefore take more risk (hold more growth assets) as the reward will be higher. Hurdle 2 on the other hand should take less risk as the age of the investor increases because the reward is less—the risk of loss is too great and the age pension may be reduced for any additional earnings made in any event.

### Step 3

All the eligible investors are selected, along with their known factors, for example age, current balance, fees paid, wages etc (typically internal factors to the collective investment data pool) and then by using a selected retirement age (i.e. 65 years old) an estimated ‘end balance’ (i.e. starting retirement balance) is calculated. Using these ‘end balances’ each investor is sorted into their relevant hurdle level and their account invested according to that hurdle level's glide path and the investor's age. For example, a 51 year old investor's end balance at age 65 is calculated using the current balance, yearly contribution levels, expected earning rate per period, fees, insurance, etc. This investor's end balance ($90,000) is under hurdle 1, they are 51 years old and therefore their money is invested 80% in equities. If they were in hurdle 2 they may be invested in 70% equities etc. This process is done on a regular basis, for example each year. These investment percentages may or may not relate to existing investment options (shares, aggressive, balanced, conservative, cash etc). Investors may or may not be informed, either pre or post fact. Existing computerised functionality to switch investors into different investment options and communicate this switch may be used.

This invention is susceptible to considerable variation in its application. Therefore, the forgoing descriptions and attached figures are not intended to limit and should not be construed as limiting the invention to the particular exemplifications presented herein above, to the extent permitted at law.

1. A computer-implemented system for automatically deriving the appropriate investment option for each investor in a collective investment data pool, comprising:
the means for processing available investor and market data,
the means for computing a matrix of ‘hurdle levels’ across the whole pool of eligible investors,
the means for setting ‘glide paths’ for each of these hurdles,
the means for automatically providing asset allocations and advice to individual investors,
the means for providing asset allocations and advice to third party entities,
including at least one:
investor,
controlling entity,
investment option, style or type,
hurdle level or similar asset goal,
glide path or similar changing ratio of asset classes expressed over time, and
end date balance.

2. The system of claim 1, applying to less than 100% of the whole pool of eligible investors.

3. The system of claim 1, applying to less than 100% of an investor's investment amount.

4. The system of claim 1, where only a selection of the available investor or market data is used in the processing.

5. The system of claim 1, applying to investors that have invested on a grouped basis.

6. The system of claim h providing automated asset allocation and/or advice only to investors.

7. The system of claim 1, providing automated asset allocation and/or advice only to a controlling third party entity.

8. The system of claim 1, where an investor has not indicated, how the investment amount, or parts thereof, is to be invested.

9. The system as claimed in h where the third party controlling entity is a trustee, or is acting on the basis of having a fiduciary duty to the investor.

10. The system as claimed in h where the investor is investing for the purposes of superannuation, retirement benefits or as a pension member and the third party controlling entity has a specific obligation to act in investors' best interests.

11. The system of claim 1, which is repeated at regular time intervals.

12. The system of claim 1, which is repeated on an event driven basis.

13. The system as claimed in 1, where the end date balance is calculated with reference to any or all of the following:
age,
balance,
fees,
insurance,
future investment earning rates,
investment withdrawal rates,
contribution rates,
retirement date(s), and
estimated age at death.

14. The system as claimed in 1, where the glide path is established with reference to any or all of the following:
age,
gender,
employer,
investment payout date(s) or terminal date,
investment option earning rates, and
probability of a loss occurring over a period.

15. The system as claimed in 1, where the hurdle levels are established with reference to any or all of the following:
eligibility criteria for the age pension or other publicly provided income support,
levels of indebtedness,
desirability to delay retirement, (i.e. due to financial constraints)
desirability to provide for bequests, (i.e. for dependants)
pension draw down levels (i.e. percentage of investment balance)
retirement lifestyle expectations or standard of living, and
taxation rates.

16. The system of claim 1, where the computer implemented system comprises separate computers.

17. (canceled)
